(19) United States
(12) Patent Application Publication
(10) Pub. No.: US 2015/0276063 A1
(43) Pub. Date: Oct. 1, 2015

(54) Flow Control Shutoff Valve

(71) Applicant: Taylor Innovations, LLC, Oklahoma City, OK (US)

(72) Inventors: Julian S. Taylor, Oklahoma City, OK (US); Bryce A. Bell, Oklahoma City, OK (US)

(73) Assignee: Taylor Innovations, L.L.C.

(21) Appl. No.: 14/668,547

(22) Filed: Mar. 25, 2015

Related U.S. Application Data
(60) Provisional application No. 61/970,029, filed on Mar. 25, 2014.

(51) Int. Cl. F16K 1/16; F16K 31/60

(52) U.S. Cl. CPC F16K 1/16; F16K 31/60

(57) ABSTRACT

A normally open flow control valve includes a housing having an inlet port, an outlet port and an interior passageway with a valve seat. A moveable valve member has a sealing head supported for rotation by a cantilevered arm. The sealing head has a sealing member adapted to establish a fluidic seal against the valve seat in a closed position. A biasing member applies a biasing force to the valve member to bring a contact surface of the valve member into contacting engagement with a distal end of a projection pin in an open position. When a flow rate of a pressurized fluid at the inlet port exceeds a selected threshold, impingement of the pressurized fluid against the sealing head rotates the valve member from the open position to the closed position.

### RELATED APPLICATIONS

This application makes a claim of domestic priority to U.S. Provisional Patent Application No. 61/970,029 filed Mar. 25, 2014, the contents of which are hereby incorporated by reference.

### BACKGROUND

Pressurized fluid systems are often used to transport and direct a pressurized fluid through a piping network. A variety of valve configurations can be used to direct and condition the fluidic flow through the system, such as pressure relief valves, emergency shutdown valves, blowdown valves, flapper valves, ball valves, pressure reducing valves (chokes), back pressure valves, pressure regulating valves, etc.

### SUMMARY

Various embodiments of the present disclosure are generally directed to an apparatus that provides emergency shutdown of a fluidic flow in response to an increase in a flow rate of the fluid.

In some embodiments, a normally open flow control valve includes a housing having an inlet port, an outlet port and an interior passageway therebetween. A valve seat is disposed within the interior passageway. A valve member disposed within the interior passageway has a sealing head supported for rotation by a cantilevered arm, the sealing head having a sealing member adapted to establish a fluidic seal against the valve seat in a closed position. A projection pin extends into the interior fluidic passage way, and a biasing member applies a biasing force to the valve member to bring a contact surface of the valve member into contacting engagement with a distal end of the projection pin in an open position. When a flow rate of a pressurized fluid at the inlet port exceeds a selected threshold, impingement of the pressurized fluid against the sealing head rotates the valve member to the closed position.

These and other features and advantages of various embodiments will become apparent by a review of the following detailed description and the accompanying drawings.

### BRIEF DESCRIPTION OF DRAWINGS

FIG. 1 is a functional block representation of a transformer coolant system to provide an exemplary environment for various embodiments of the present disclosure.

FIG. 2 is a perspective view of a flow control shutdown valve suitable for use in the system of FIG. 1.

FIG. 3 is a side cross-sectional view of the valve of FIG. 2 in a normally open position with a rotatable valve member of the valve in a first initial rotational position (angle).

FIG. 4 shows the valve of FIG. 3 with the rotatable valve member rotated to a closed position.

FIG. 5 depicts a valve adjustment mechanism of the valve with the rotatable valve member in a second initial rotational position (angle).

FIG. 6 is an end cross-sectional view of the valve of FIG. 3.

### DETAILED DESCRIPTION

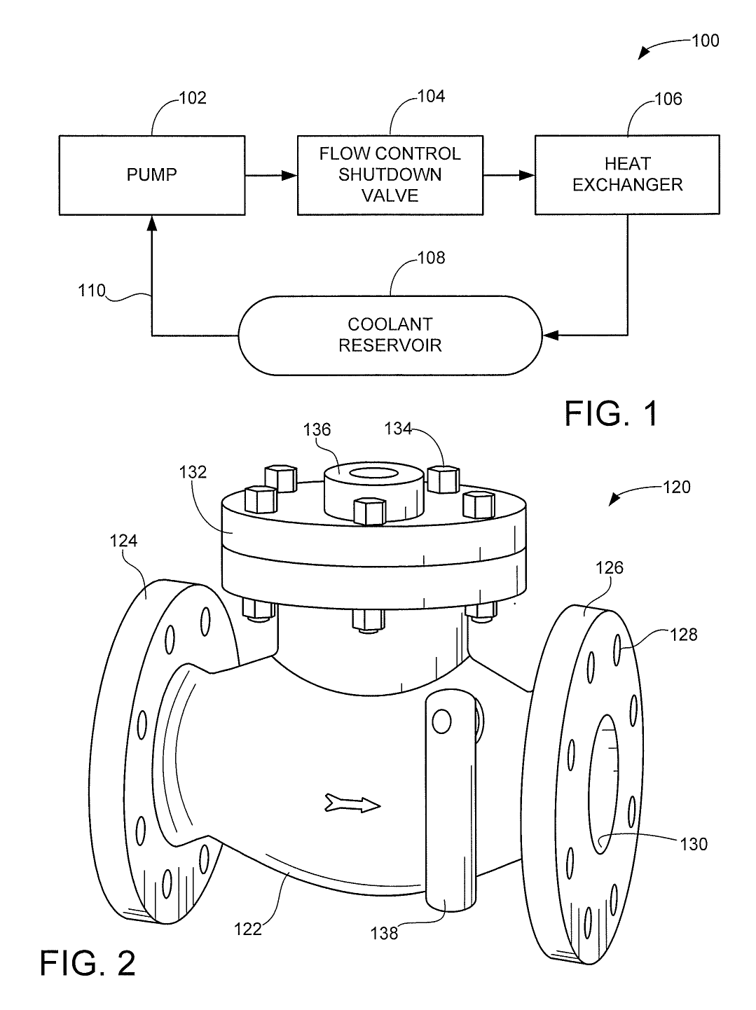

Without limitation, various embodiments of the present disclosure are generally directed to a flow control shutdown valve. As explained below, in at least some embodiments the valve is adapted for use in a pressurized fluid piping network to provide emergency shutdown operation in response to an increase in the flow of the transported fluid. The valve can be used in any number of different operational environments, such as an exemplary transformer cooling system 100 depicted in FIG. 1.

The system 100 includes a recirculating pump 102, a flow control shutdown valve 104, a heat exchanger 106 and a coolant reservoir 108. Other elements can be incorporated into the system 100 as desired. A suitable coolant fluid such as oil or a glycol-water mixture is circulated through suitable conduit pipes (generally denoted at 110) to remove waste heat from a heat load, such as one or more power transformers (not separately shown).

While any number of pressure ranges can be used, it is contemplated in some embodiments that the pump 102 will establish a relatively low pressure of the fluid as it circulates, such as on the order of about 12 pounds per square inch (psi). Other pressure ranges can be used and the valve is not necessarily limited to such relatively low pressures. In one embodiment, the normal pressure of the pressurized fluid is in a range of from about 2 pounds per square inch (psi) to about 25 psi. The conduit pipes 110 are sized to accommodate the desired flow rate, and may be on the order of about two inches in diameter (2 in. ID) or some other value.

As will be recognized, the flow rate of a fluid, also referred to as the volumetric flow rate Q, represents the volume of fluid which passes a given point in the system per unit of time. Q may be expressed as cubic feet per second (ft³/s), gallons per minute (gal/min), cubic centimeters per second (cc³/s), etc. Albeit related, flow rate Q is distinct from the pressure P of a fluid.

Pressure is generally represented as a force of the fluid acting per unit area and may be expressed as pounds per square inch (lbs/in² or psi), newtons per square meter (N/m² or pascals, Pa), etc. A difference in pressure may induce flow, but the volume of the flow will be governed by other state variables such as cross-sectional area available to the fluid, etc. The significance of this distinction between flow rate and pressure will be apparent below.

FIG. 2 is a perspective view of a flow control shutdown valve 120 suitable for use in the system 100 of FIG. 1 to provide emergency shutdown operation in the event of an increase in fluidic flow (increased Q) of the coolant fluid. The reason for an increase in fluidic flow is not necessarily germane to the present discussion since a number of factors can arise that would result in an increased flow depending upon the operational environment.

In one example, damage incurred to the system 100 of FIG. 1, such as through a leak or break in the conduits 110 downstream from the valve 120, could result in an increase in fluidic flow due to an increased system pressure differential across the valve. It is presumed that other suitable shutdown protocols are in place to address the resulting shutoff of the cooling fluid by the valve 120, such as by deactivation of the load, bypass and/or shutdown of the pump, etc.

Interior aspects of the valve 120 will be discussed below, but at this point it can be seen that the valve includes a rigid in-line housing 122 with opposing inlet and outlet flanges 124, 126. The housing and flanges may be formed as an integral piece of any suitable material including metal, plastic, etc. In some cases, the housing and flanges are formed of ABS plastic (acrylonitrile butadiene styrene) or PVC (polyvinyl chloride) using an injection molding operation.

The inlet and outlet flanges 124, 126 are adapted to be connected to corresponding couplings of the conduit pipes 110 (FIG. 1) using threaded fasteners (not shown) that extend through spaced apart apertures 128. An inlet port (not visible in FIG. 2) extends through the inlet flange 124 to provide ingress of the fluidic flow. An outlet port 130 extends through the outlet flange 126 to provide egress of the fluidic flow. The flanges 124, 126 are optional.

The valve 120 as configured in FIG. 2 is an in-line valve so that the inlet and outlet ports are axially aligned, although the housing 122 can take any suitable shape, including non-inline configurations, as required. For example, in an alternative embodiment the outlet port is arranged at nominally 90 degrees with respect to the inlet port.

A cover plate 132 is affixed to an upper portion of the housing 122 via an array of threaded fasteners 134. The cover plate 132 includes a central boss projection 136 into which a valve adjustment mechanism extends. A user operated, spring-loaded reset handle 138 extends from a side of the housing 122. Both the valve adjustment mechanism and the handle will be discussed in greater detail below.

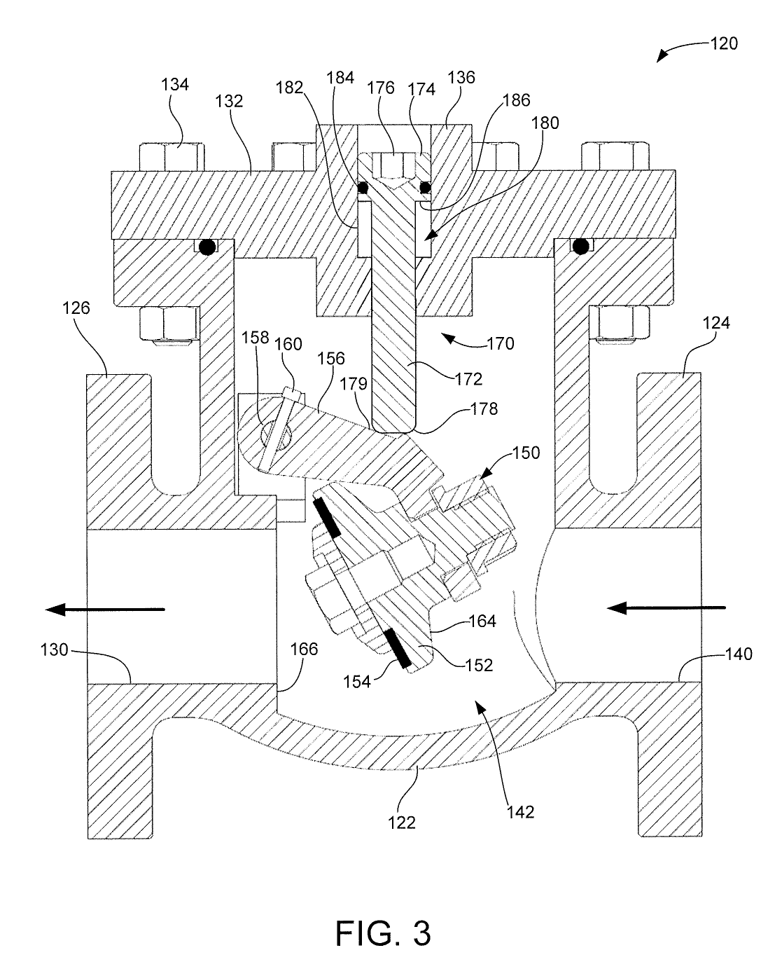

FIG. 3 shows a cross-sectional depiction of the valve 120 of FIG. 2 in accordance with some embodiments. The valve 120 is reversed as compared to the view in FIG. 2, so the inlet flange 124 and aforementioned inlet port 140 are located on the right-hand side of FIG. 3, and the outlet flange 126 and outlet port 130 are located on the left-hand side of FIG. 3. The handle 138 from FIG. 2 is behind the housing 122 and hence, not visible in FIG. 3.

An interior fluidic passageway 142 is formed within the housing 122 between the inlet and outlet ports. Disposed within the passageway 142 is a flapper-type valve member 150. The valve member 150 is in a normally open position as shown in FIG. 3 to allow the coolant fluid to flow through the housing.

The valve member includes a sealing head 152 with an annular sealing member 154. The sealing head 152 can be formed of a single piece or multiple assembled pieces, as shown. The sealing head 152 is supported by a cantilevered arm 156. The arm 156 is affixed for rotation about a central axis that passes through a transverse shaft 158 affixed to the handle 138 (FIG. 2). A retention fastener 160 extends through the arm 156 and shaft 158 so that these members, along with the sealing head 152, rotate as a unit. It is contemplated that the sealing head 152 will remain fixed in relation to the arm 156, but in other embodiments the sealing head may be permitted to axially rotate relative to the arm.

Inlet fluid impinges against an outer surface 164 of the sealing head 152. A biasing member (not shown in FIG. 3), such as a coiled spring, applies a biasing force that urges the valve member 150 to the open position as shown in FIG. 3.

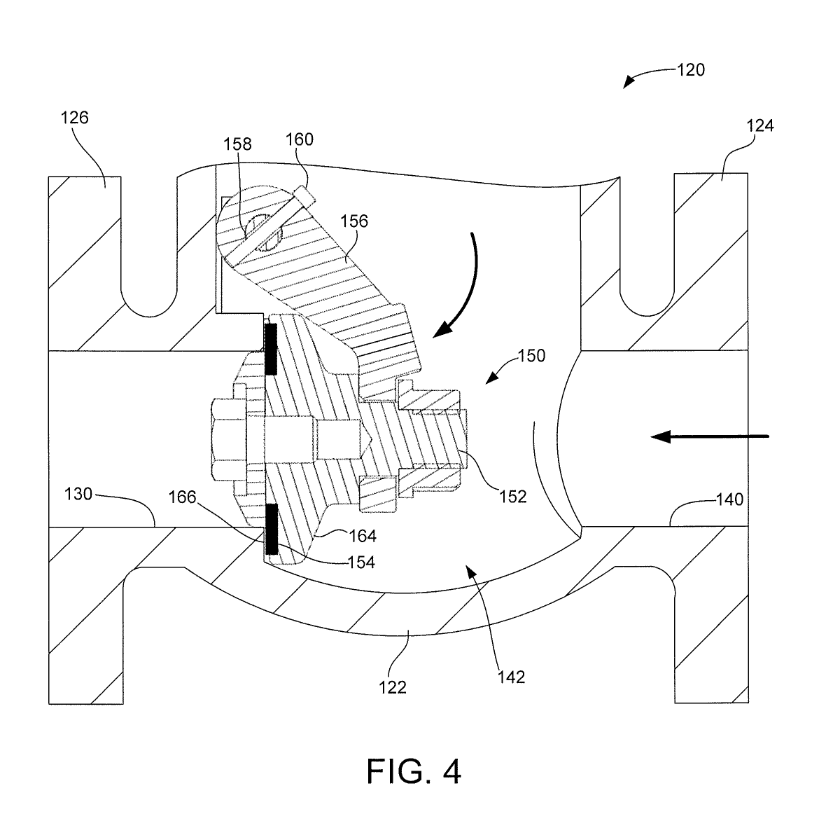

During normal operation, the circulating coolant fluid will flow through the housing 122 from the inlet port 140 to the outlet port 130. At such time that the magnitude of the flow provides a force upon the outer surface 164 of the sealing head 152 that overcomes the biasing force supplied by the biasing member, the valve member 150 will rotate about the central axis of the shaft 158 and transition to a closed position, as generally depicted in FIG. 4.

In the closed position, the sealing member 154 of the sealing head 152 establishes a fluidic seal against a valve seat surface 166 to impede further flow of the fluid through the housing 122. Depending on the rate of flow of the coolant fluid, in some cases the valve member 150 may only partially close as the fluid urges the sealing head 152 toward the valve seat surface 166, thereby restricting the cross-sectional area of the interior flow passageway 142 available for use by the fluid as the fluid flows through the housing. In other cases, the rate of flow of the fluid will be sufficient to fully seat the sealing head 152 against the valve seat surface 166 and shut off further flow through the valve 120. In this way, the valve 120 operates to regulate the volumetric flow rate of the fluid through the system 100.

Returning again to FIG. 3, a valve adjustment mechanism is generally denoted at 170. The valve adjustment mechanism 170 generally comprises a threaded projection pin 172 which extends through a threaded aperture in the cover plate 132 and into the interior flow passageway 142. The projection pin 172 includes a head 174 with an interior hex driving surface 176 to permit a user activated driver tool (not shown) to rotatably advance or retract a distal end 178 of the pin 172 within the housing. This changes the relative location of the distal end 178 of the pin 172.

Threads (not separately shown) extend along the length of the pin 172 from the head 174 to the distal end 178. These threads engage corresponding threads in the cover plate 132 (not separately shown) to facilitate the advancement and retraction of the pin 172. A shorter run of threads along an appropriate operative area of the pin can be provided as desired.

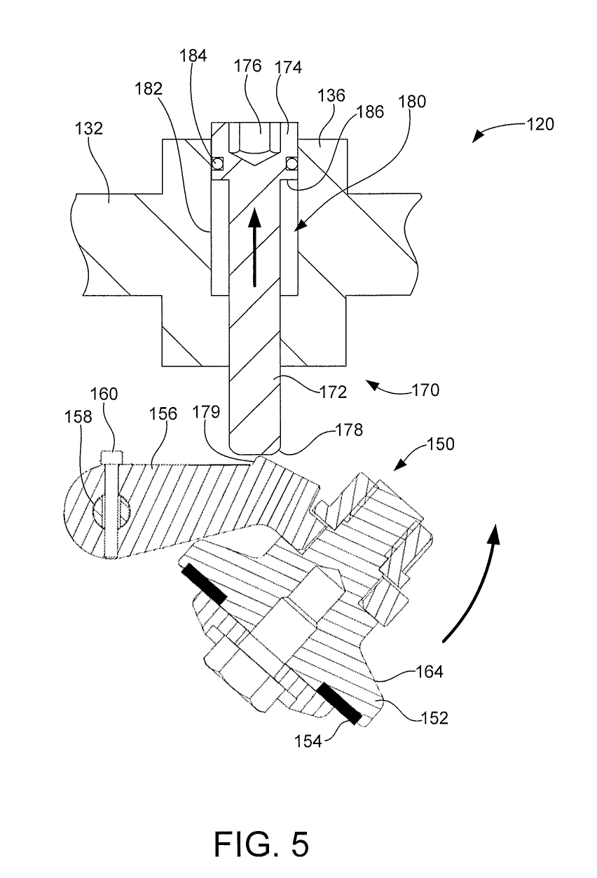

The distal end 178 of the pin 172 serves as a limit stop to set the initial angular orientation of the valve member 150 through contact between the distal end 178 of the pin 172 and a limit surface 179 of the cantilevered arm 156. A relatively higher initial location of the distal end 178 will place the sealing head 152 at a first rotational position (angle) that is higher up and more out of the way of the inlet fluid flow, as generally depicted in FIG. 5. Lowering the distal end 178 of the pin 172 will place the sealing head at a lower second rotational position (angle) that is more in the way of the inlet fluid flow, as depicted in FIG. 3.

By threadingly advancing or retracting the pin 172, the pin can be easily raised or lowered to adjust the valve member 150 to any suitable rotational position over a continuous range of available positions. The available positions range from a fully open position (at which a significant increase in fluidic flow is required to close the valve) to a position that is almost closed (so that a relatively small increase in fluidic flow is sufficient to close the valve). It follows that a greater amount of fluid flow will be required to transition the valve to the closed position if the valve is configured at the first rotational position shown in FIG. 5 as compared to the second rotational position in FIG. 3, due to the different locations and presentation angles of the sealing head 152.

By setting the initial rotational position of the valve member 150, a series of setpoint flow rate thresholds can be established responsive to the biasing force of the spring and the angle of the valve member. An increase in the flow rate above a first threshold level will initiate partial advancement of the valve member 150 toward the valve seat surface 166, thereby restricting the volumetric flow of the fluid exiting the valve 120.

As the inlet flow rate continues to increase to above a second threshold level, the valve member 150 will fully seat against the valve seat surface 166, thereby shutting off further flow (e.g., restricting the flow to zero). It will be noted that because the valve 120 operates responsive to changes in fluidic flow, the inlet pressure may remain nominally at a normal system level as the valve transitions to the closed position.

The head 174 of the pin 172 rotationally advances within a chamber 180 of the cover plate 132, and a fluidic seal is established between the head 174 and an annular sidewall 182 of the cover plate 132 using a sealing member (o-ring) 184. A lower annular shoulder surface 186 of the head 174 provides a lower limit surface for the location of the distal end 178 of the pin 172. An upper limit surface (not separately shown) may be additionally supplied to ensure the sealing member 184 remains in contact with the sidewall 182. For example, a retention mechanism, such as a threaded nut, may be applied to the pin 172 to prevent the head 174 from being retracted far enough out of the chamber 180 that the fluidic seal between 182, 184 is released.

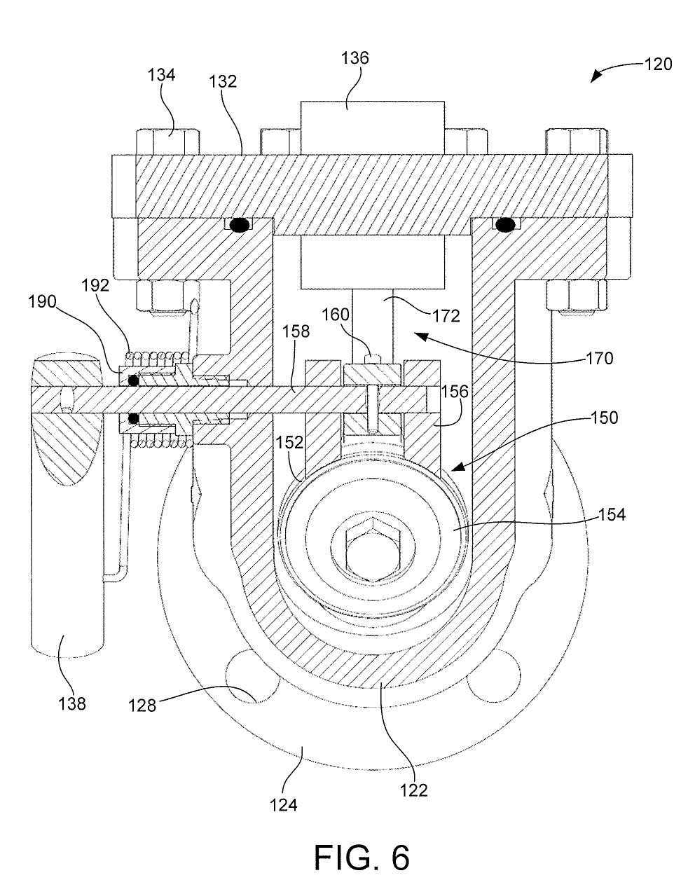

FIG. 6 shows another cross-sectional view of the valve 120. The view in FIG. 6 is generally in a direction from the outlet port 130 toward the valve member 150. The aforementioned shaft 158 coupled to the valve member 150 extends through a boss projection 190 of the housing to the handle 138 (FIG. 2). A coiled spring 192 includes a number of coils that extend around the boss projection 190 and respectively engage the handle 138 and the housing 122. In this way, the valve member 150 is normally biased against the distal end 178 of the pin 172 (see e.g., FIGS. 3, 5).

The handle 138, shaft 158 and spring 192 thus form a reset assembly that enables a user to reset the valve 120 to the open position in the presence of fluidic pressure and/or flow at the inlet port 140. The user can rotate the handle to reset the valve member 150 to the open position (see FIG. 3), and the spring 192 will thereafter retain the valve member in this position. However, the use of a handle such as 138 is optional as other mechanisms can be used to reset the valve 120. The handle 138 serves as a ready visual indicator of the position of the valve (e.g., open or closed).

A weather cover (not shown) can be incorporated to enclose or otherwise protect the exposed spring from the accumulation of ice or other effects that might tend to impede the operation of the spring. In another embodiment, the spring is located within the housing 122.

It is contemplated albeit not necessarily required that the spring will have sufficient force to return the valve member 150 to the open position (e.g., seated against pin 172) in the absence of pressure or fluidic flow. If some pressure is present, however, user intervention may be required, via the handle, to return the valve to the open position. Other mechanisms such as automated retractors, actuators, motors, solenoids, etc. may be configured to rotate the valve member to the open position during a reset operation. Other biasing members apart from a coiled spring, such as a counterweight, a membrane, other energy storage mechanisms, magnets, etc., can similarly be used to apply the biasing force to the open position.

While various embodiments have been generally directed to a flow control valve for a cooling system application, such is merely illustrative and not limiting. Aspects of the various embodiments presented herein can be adapted for use in any number of suitable environments in which a pressurized fluid is passed through a system.

What is claimed is:

1. A normally open flow control valve, comprising:
a housing having an inlet port, an outlet port and an interior passageway therebetween;
a valve seat disposed within the interior passageway;
a valve member disposed within the interior passageway the valve member comprising a sealing head supported for rotation by a cantilevered arm, the sealing head comprising a sealing member adapted to establish a fluidic seal against the valve seat in a closed position;
a projection pin extending into the interior fluidic passage way; and
a biasing member which applies a biasing force to the valve member to bring a contact surface of the valve member into contacting engagement with a distal end of the projection pin in an open position, wherein when a volumetric flow rate of a pressurized fluid at the inlet port exceeds a selected threshold, impingement of the pressurized fluid against the sealing head rotates the valve member to the closed position.

2. The valve of claim 1, wherein the cantilevered arm of the valve member is affixed to a shaft rotatable about a central axis, and wherein the valve further comprises a handle coupled to the shaft, the handle having a grip surface adapted to be grasped by the hand of a user so that rotation of the handle by the user transitions the valve member between the closed position and the open position.

3. The valve of claim 2, wherein the biasing member is a spring affixed to the handle, the spring urging concurrent rotation of the handle and the valve member toward the open position.

4. The valve of claim 2, wherein the shaft extends through the housing, the handle is disposed adjacent an exterior surface of the housing, and the biasing member is adapted to concurrently rotate the handle and the valve member.

5. The valve of claim 1, further comprising a valve adjustment mechanism configured to respectively advance and retract the distal end of the pin relative to the valve member to place the valve member at different initial rotational angles in the open position.

6. The valve of claim 5, wherein the valve adjustment mechanism comprises a threaded member which, when rotated, advances and retracts the distal end of the pin within the interior passageway.

7. The valve of claim 1, wherein the housing is formed of plastic.

8. The valve of claim 1, wherein the biasing member comprises a spring.

9. The valve of claim 1, wherein the pressurized fluid comprises a coolant fluid used to remove heat from an operational load.

10. The valve of claim 1, wherein a normal pressure of the pressurized fluid while the valve is in the open position is in a range of from about 2 psi to about 25 psi.

11. The valve of claim 1, characterized as an in-line valve so that the inlet port is axially aligned with the outlet port.

12. A normally open flow control valve, comprising:
a housing having an inlet port, an outlet port and an interior passageway therebetween;
a valve seat disposed within the interior passageway;
a limit stop which extends into the interior passageway;
a valve member within the interior passageway comprising a sealing head and a cantilevered arm, the arm having a first end attached to the sealing head and an opposing second end attached to a rotatable shaft so that, responsive to rotation of the shaft, the sealing head follows an arcuate path between an open position and a closed position; and
a biasing member which applies a biasing force to the shaft to urge the cantilevered arm against the limit stop in the open position, wherein the sealing head is configured to rotate to the closed position responsive to an increase of volumetric flow of a fluid passing through the inlet port.

13. The valve of claim 12, further comprising an exterior handle coupled to the shaft, the handle having a grip surface adapted to be grasped by the hand of a user so that rotation of the handle by the user transitions the valve member between the closed position and the open position.

14. The valve of claim 12, further comprising a valve adjustment mechanism configured to respectively advance and retract the distal end of the limit stop relative to the cantilevered arm to place the valve member at different initial rotational angles in the open position.

15. The valve of claim 14, wherein the valve adjustment mechanism comprises a threaded member which, when rotated, advances and retracts the distal end of the pin within the interior passageway.

16. The valve of claim 12, wherein the sealing head comprises an elastomeric sealing member which contactingly engages the valve seat to shut off flow of the fluid through the housing.

17. The valve of claim 12, wherein a normal pressure of the fluid at the inlet of the housing while the valve member is in the open position is in a range of from about 2 psi to about 25 psi, and the normal pressure of said fluid remains nominally constant as the valve member transitions to the closed position responsive to the increase in the volumetric flow.

18. The valve of claim 1, wherein the housing is formed of plastic.

19. The valve of claim 1, wherein the biasing member comprises a spring.

20. The valve of claim 1, wherein the pressurized fluid comprises a coolant fluid used to remove heat from an operational load.
